(19) United States
(12) Patent Application Publication
(10) Pub. No.: US 2013/0114410 A1
(43) Pub. Date: May 9, 2013

(54) Network Relay Device, Control Method for Network Relay Device, and Recording Medium on which Program for Controlling Network Relay Device Is Recorded

(71) Applicant: BUFFALO INC., Nagoya-shi (JP)

(72) Inventor: Yoshiki Nagato, Nagoya-shi (JP)

(73) Assignee: BUFFALO INC., Nagoya-shi (JP)

(21) Appl. No.: 13/668,333

(22) Filed: Nov. 5, 2012

(30) Foreign Application Priority Data
Nov. 9, 2011 (JP) 2011-245808

(51) Int. Cl. H04L 12/24

(52) U.S. Cl. 370/235

(57) ABSTRACT

In a state where a network relay device 10 receiving packets whose share of TCP packets requiring reliability is high, a flow control function is automatically set to be operative. This configuration enables suppression of overflow of the buffer of a switching engine 121, enabling high-reliability communications. Conversely, in a state where the network relay device 10 receiving packets whose share of UDP packets is high, a flow control function is automatically set to be inoperative. This configuration enables communications with higher real-time responsiveness than when the flow control function is set to be operative. When the flow control function is set to be inoperative, UDP packets are transmitted with priority over TCP packets. Therefore, setting of the flow control function to be inoperative coupled with transmission of UDP packets with priority enables communication with yet higher real-time responsiveness than when the flow control function is set to be inoperative.

### BACKGROUND OF THE INVENTION

1. Technical Field

The present invention relates to network relay devices for transmitting/receiving packets in network communications, to methods of controlling the network relay devices, and to recording media containing a control program for the network relay device.

2. Description of the Related Art

Internet Protocol (IP) functions to deliver data packets from a transmission origin to a transmission destination. In an IP network, Transmission Control Protocol (TCP) and User Datagram Protocol (UDP) are used as transport layer protocols.

TCP is a connection-type protocol whereby connection between terminals at a transmission origin and a transmission destination is established before data communications are carried out. With TCP, maintaining the state of communications once a connection is established between terminals is carried out, and checking for errors in packets, such as whether packets are lost, redundant, or out of sequence, is carried out as well. And further, a retransmission control process in which packets are retransmitted for error correction is performed. As a result of these practices, error-free, highly reliable packet transmission is enabled. On the other hand, owing to the establishment and breaking of the connection, the correction confirmation, the retransmission control process, etc., carrying out packet-based data communications takes time, on account of which the time to the completion of a data transfer is prolonged, compromising real-time responsiveness.

Meanwhile, UDP, as distinct from TCP, is a connectionless-type protocol that does not establish a connection between a transmission origin and a transmission destination. Also unlike the case with TCP, UDP does not perform checking for errors, correction of errors, or retransmission control processes, and rather only transmits data unilaterally from a transmission origin to a transmission destination using packets. As a result of these differences, problems such as packets being out of sequence, lost, redundant may occur. UDP, however, does not perform establishment and breaking of a connection, correction confirmation, or retransmission control processes, thus taking a shorter time for carrying out data transmission using packets, resulting in superior real-time responsiveness.

In a relative comparison between TCP and UDP, packet communications using TCP are characterized as superior in reliability and inferior in real-time responsiveness, while UDP is characterized as superior in real-time responsiveness and inferior in reliability, as described above.

Taking advantage of the difference in characteristics as described above, TCP is established in cases, such as file transfer and email transmission/reception between terminals, in which the reliability is more important than the real-time responsiveness in communications. In contrast, UDP is established in cases, such as voice communications and motion image distribution, in which the real-time responsiveness is more important than the reliability in communications.

The transmission/reception of packets between terminals is relayed by a network relay device such as a switching hub or a router, in most cases. Here, whether to transmit/receive a packet using TCP or UDP is specified by a program (e.g., Web browser, IP telephony, movie playback, and file transmission) that is executed on the terminal of a transmission origin, and therefore packet communications using TCP and UDP may possibly be carried out in parallel on the network relay device. In this case, the network relay device is required to balance the real-time responsiveness and the reliability.

A configuration enabled for such balancing includes a network relay device provided with a priority control function. The priority control function is a function of determining priority for received packets and transferring the packets on a priority basis. It is possible to carry out communications with high real-time responsiveness by using the priority control for assigning high priority to a packet requiring real-time responsiveness.

Further, in addition to the network relay device provided with the priority control function, as another means for carrying out the balancing described above, a network relay device with built-in band-control functionality is known. (Reference is made to Japanese Unexamined Pat. App. Pub. No. 2002-217966.) “Band control functionality” means functions of, on a per-packet-category basis, securing as well as restricting the bands that may be used. It is possible to carry out communications with high real-time responsiveness by using the band control to allocate a band, on a priority basis, to a packet requiring real-time responsiveness.

However, the transfer of UDP packets requiring real-time responsiveness on a priority basis using the priority control, and the securing of a band for UDP packets requiring real-time responsiveness on a priority basis using the band control gives rise to the following problems.

Namely, a network relay device has a buffer for temporarily storing packets. Packets received by the network relay device are temporarily stored in the buffer and are transmitted to a destination. Here, there is a possibility of accumulating too many packets, exceeding the capacity of the buffer. Exceeding the capacity of the buffer leads to loss of packets, compromising the reliability. Therein, if priority control or band control is used to transfer packets on a priority basis or to secure bands on a priority basis, TCP packets cannot be transmitted to a destination from the network relay device on a priority basis. In such an event, retransmission control is carried out for TCP packets having overflowed from the buffer. The execution of a retransmission control process will transmit the overflow amount of packets once again to the network relay device, causing the packets to easily overflow, and the problem of this vicious cycle of sorts will result. For resolving such a problem, a network relay device furnished with flow-control functionality is commercially available.

The flow control function is an adjustment function for interrupting the transmission of a packet to the terminal of the transmission origin, or for limiting the transmission speed, so as to prevent the buffer from overflowing. Whether to set the flow control function of the network relay device to be operative or inoperative is statically set by an administrator of the network relay device in accordance with the installed environment of the device. The flow control function makes it possible to prevent loss of packets due to overflow from the buffer of the network relay device, enabling highly reliable communications. However, the real-time responsiveness of the communications is undermined by the interruption of the transmission of the packets or the limiting of the transmission speed.

As described above, the real-time responsiveness and the reliability are not necessarily well balanced by merely furnishing a network relay device with a priority control function, a band control function, and a flow control function in an environment where packets with the reliability being priority and those with the real-time responsiveness being priority coexist. That is the current situation.

### BRIEF SUMMARY OF THE INVENTION

An object of the present invention, brought about taking the above-discussed state of affairs into consideration, is to make available a network relay device, a method of controlling the network relay device, and a program for controlling the device whereby in situations where among a plurality of terminals, communications in which reliability is emphasized are carried out intermingled with communications in which real-time responsiveness is emphasized, automatically switching to a communications method suited to the state of the communications is made possible.

Various means effective for resolving the above described problems are described in the following, while result and effects are indicated as necessary.

A network relay device according to the present invention is a network relay device for transmitting/receiving data packets, the network relay device including: a state-of-use determination unit for determining, in response to at least either packets that the network relay device receives or packets that the network relay device transmits, the network relay device's state of use; a flow-control unit for controlling flow volume of packets that the network relay device receives; and a mode-switching unit for switching control by the flow-control unit between operative and inoperative, in response to the state-of-use determined by the state-of-use determination unit.

The configuration described above allows the flow-control unit to control the flow volume of packets by temporarily inhibiting transmission of packets from a terminal and adjusting the transmission speed, thereby enabling the network relay device to transmit/receive packets by means of a highly reliable communication method preventing loss of packets. Further, in a case where the state-of-use determination unit determines that, for example, there are a large number of packets requiring real-time responsiveness, it is possible to cause the mode-switching unit to switch modes so as to set the control of the flow-control unit to be inoperative. It is therefore also possible to set the control of the flow-control unit to be inoperative in accordance with the state of use, thereby enabling transmission/reception of packets by means of a communication method with high real-time responsiveness. An automatic changing of the modes of the flow-control unit in accordance with the state of use of the network relay device as described above enables an automatic selection of a communication method suitable for the state of communications.

A network relay device according to the present invention includes a priority-control unit for controlling transmission of packets requiring real-time responsiveness with priority over packets requiring reliability when control of the flow-control unit is set to be inoperative.

The configuration described above makes it possible to cause the priority control unit to transmit a packet requiring real-time responsiveness on a priority basis when the control of the flow-control unit is set to be inoperative. This sets the flow-control unit to be operative in a state of use requiring reliability while sets the flow-control unit to be inoperative in a state of use requiring real-time responsiveness, thereby switching modes so that the priority-control unit to function and making it possible to appropriately respond to a contradictory situation in which a state of use requiring reliability and a state thereof requiring real-time responsiveness coexist. Here, a typical example of a packet requiring reliability is a TCP packet, while that of a packet requiring real-time responsiveness is a UDP packet. It will be appreciated that the priority-control unit carrying out “control for transmitting a packet requiring real-time responsiveness with priority over a packet requiring reliability” includes not only priority control that determines a degree of priority for packets requiring reliability to transmit the packets on a priority basis, but also band control that secures a band allowed for transmitting the packets requiring reliability, or a method of performing both the priority control and the band control.

In a network relay device according to the present invention, the state-of-use determination unit calculates a share occupied by packets of a predefined category in received packets and determines the state of use on the basis of the share.

The configuration described above makes it possible to calculate the share of packets of a predefined category by monitoring packets that the network relay device receives in determining the state of use thereof, facilitating the state-of-use determination unit to make an objective determination and enabling an appropriate switching of modes as a result.

In a network relay device according to the present invention, the state-of-use determination unit uses, as packets of the predefined category, packets requiring real-time responsiveness or packets requiring reliability for calculating the share.

The configuration described above makes it possible to grasp the share of at least either packets requiring reliability, or those requiring real-time responsiveness, thereby facilitating determination as to whether a state of use in need of reliability or a state thereof in need of real-time responsiveness.

In a network relay device according to the present invention, the state-of-use determination unit calculates the share on the basis of the number of packets received in any given period of time.

The configuration described above makes it possible to acquire a share based on the number of packets in any given period of time, enabling grasping of the share just by counting the packets as an actual process, provided that the period of time is fixed, and facilitating the calculation of the share as a result.

In a network relay device according to the present invention, the state-of-use determination unit weights the calculated share corresponding to a port number used for specifying a program of a destination of transmitting a packet and determines the state of use on the basis of the weighted share.

In a case where a share is simply calculated, there is a possibility of being unable to appropriately change modes for a program used at a destination of transmission of an important packet that requires a special attention. In this respect, the configuration described above is adapted to give weighting to a program used at a destination of transmission of an important packet that requires a special attention to determine a state of use, thereby enabling better prioritization for the important packet than with the case of simply comparing the numbers of packets.

In a network relay device according to the present invention, the state-of-use determination unit determines the state of use on the basis of a temporal change of the share.

The configuration described above makes it possible to predict a share for a near future by taking the temporal change of the share into consideration. Therefore, it enables the mode-switching unit to change modes in accordance with a predicted state of use in a near future.

In a network relay device according to the present invention, the state-of-use determination unit records a temporal change of the flow-control unit being operative and inoperative as a history and determines the state of use on the basis of the history and the share.

The configuration described above makes it possible to grasp a trend, such as there are more situations in which a terminal connected to the network relay device needs reliability, or there are more situations in which the terminal needs real-time responsiveness, from the recorded history. It is possible to appropriately switch modes by using the grasped trend.

In a network relay device according to the present invention, the state-of-use determination unit determines the state of use on the basis of continuity of packets of a predefined category when they are received, transmitted, or both received and transmitted.

The configuration described above makes it possible to also determine that the share of packets of a predefined category is on the increase if there is continuity of the packets of the predefined category received by the network relay device. Using the determination, it is possible to appropriately switch modes without calculating the share of the packets of the predefined category, and switch modes well-suited to the state of use on the basis of both the continuity of packets of the predefined category and the actual share thereof.

In a network relay device according to the present invention, the mode-switching unit inhibits switching control by the flow-control unit between operative and inoperative until a predetermined period of wait time elapses after switching the control by the flow-control unit between operative and inoperative.

Reconnection is needed between a network relay device and a terminal connected thereto in order to switch the flow control function of the network relay device from operative to inoperative or vice versa. Further, if processes such as connection, interruption, and reconnection are performed between the network relay device and the connected terminal, data communications cannot be carried out during the processes. Therefore, the inhibition of switching of modes again in the predetermined period of time after switching the modes produces an effect of reducing periods of interrupting data communications compared to the case of not inhibiting the switching, thereby providing advantageous communication condition when the flow control function is set to be both operative and inoperative.

A network relay device according to the present invention includes a plurality of ports used for connecting to external terminals, wherein: the flow-control unit is capable of controlling a flow volume of packets received by the network relay device at each of the ports; and the mode-switching unit is capable of switching control by the flow-control unit between operative and inoperative for each of the ports.

The configuration described above includes a plurality of ports, thereby enabling the network relay device to relay a plurality of external terminals. Here, the connected terminals are different for individual terminals, and it is therefore possible to perform fine control for each port by setting the flow control function for the individual ports in accordance with the respective states of transmission/reception of packets at the individual ports.

It is assumed that the network relay device described above is to be applied to a switching hub as one of the representative exemplary embodiments. Further, the means described above have been described in assumption of a network relay device. It is, however, possible to resolve the above described problem also by providing a control method for the network relay device, a control program therefor, and a recording medium recording thereon the control program.

### BRIEF DESCRIPTION OF THE SEVERAL VIEWS OF THE DRAWINGS

FIG. 1 is a diagram representing the hardware configuration of a network relay device;

FIG. 2 is a functional block diagram of the network relay device;

FIG. 3 is a flowchart representing procedural flows in a periodical process;

FIG. 4 is a flowchart representing procedural flows in a mode determination process;

FIG. 5 is a flowchart representing procedural flows in a mode-switching process;

FIG. 6 is a flowchart representing procedural flows in Modification Example (1) of a mode determination process;

FIG. 7 is a sequence chart representing procedural flows in Modification Example (2) of a mode determination process;

FIG. 8 is a sequence chart representing procedural flows in Modification Example (3) of a mode determination process; and

FIG. 9 is a sequence chart representing procedural flows in Modification Example (4) of a mode determination process.

### DETAILED DESCRIPTION OF THE INVENTION

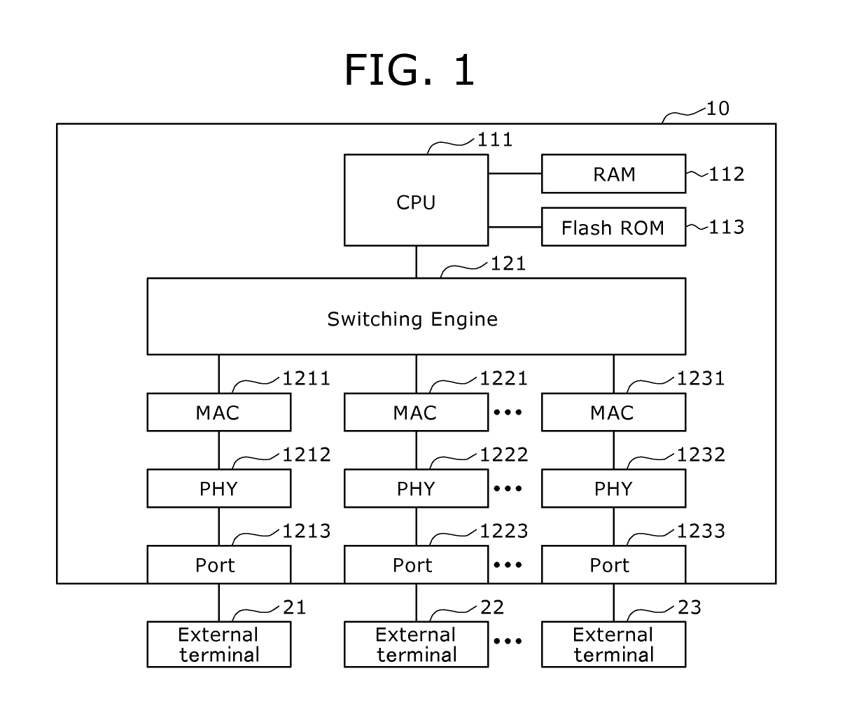

A network relay device 10 according to the present embodiment is described in the following. FIG. 1 is a simplified diagram illustrating the hardware configuration of a network relay device 10 according to the present embodiment.

The network relay device 10 is, for example, a switching hub according to the present embodiment. Here, the network relay device 10 may also be a router or a Layer-3 switch, in addition to being the switching hub. The network relay device 10 includes: a central processing unit (CPU) 111; random access memory (RAM) 112; flash read only memory (ROM) 113; a switching engine 121; media access control (MAC) chips 1211, 1221 and 1231; physical layer chips (called “PHY” hereinafter) 1212, 1222 and 1232; and ports 1213, 1223 and 1233. Further, the switching engine 121 and the MAC chips 1211, 1221 and 1231 are incorporated into an integrated circuit (IC) chip to constitute a switching controller. Here, the PHY 1212, 1222 and 1232 may further be integrated into an IC chip to constitute the switching controller. There are provided a plurality of ports 1213, 1223 and 1233; and the MAC chips 1211, 1221 and 1231 and the PHY 1212, 1222 and 1232 are disposed respectively to the ports 1213, 1223 and 1233. The network relay device 10 is connected to external terminals 21, 22 and 23 via the ports 1213, 1223 and 1233. The aforementioned connection is arranged in compliance to, for example, a connection scheme called Ethernet (Registered Trademark) standardized by IEEE802.3 and has, for example, a full duplex or half duplex communication speed of 10 Mbps, 100 Mbps, 1 Gbps or 10 Gbps.

Packets that each has a form of an electric signal and are transmitted from the external terminals 21, 22 and 23 are converted into data by the PHY 1212, 1222 and 1232. The packets converted into data are further transmitted to the MAC chips 1211, 1221, and 1231. Here, the individual MAC chips 1211, 1221, and 1231 respectively have specific identification numbers. The individual MAC chips 1211, 1221, and 1231 are interconnected via the switching engine 121.

The MAC chips 1211, 1221, and 1231 convert each of the received packets into a MAC frame format and transmits them to the switching engine 121. The switching engine 121, furnished with a not-shown buffer, temporarily stores the packets received from the MAC chips 1211, 1221, and 1231 in the buffer. Further, the switching engine 121 is connected to the CPU 111. The CPU 111 is connected to the RAM 112 and the flash ROM 113.

The flash ROM 113 stores therein a program for controlling the switching engine 121. The CPU 111 develops the program for controlling the switching engine 121 on the RAM 112 and executes the program. The CPU 111 obtains, from the switching engine 121, information related to the packets (called “packet information” hereinafter) stored in the buffer. Further, on the basis of the packet information the CPU 111 controls either the switching engine 121 or the MAC chips 1211, 1221 and 1231. Here, “packet information” is information, stored in the packets, including the protocol and port number that received packets use, and each packet's packet length.

The switching engine 121 transmits packets of a MAC frame format, the packets stored in the buffer, to the MAC chips 1211, 1221 and 1231 in accordance with the packet information included in the respective packets. The MAC chips 1211, 1221 and 1231 transmit the packets to the external terminals 21 through 23 via the PHY 1212, 1222 and 1232, and the ports 1213, 1223 and 1233, the packets received from the switching engine 121.

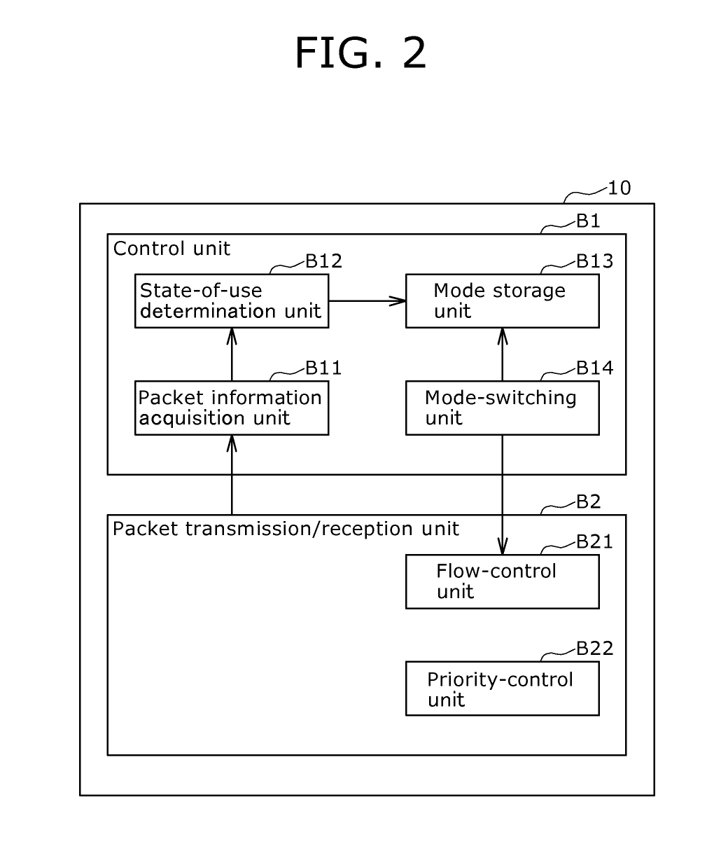

FIG. 2 is a functional block diagram focusing on the function of the network relay device 10 that has a hardware configuration as described above. The network relay device 10 includes a control unit B1 and a packet transmission/reception unit B2. The control unit B1 includes a packet information acquisition unit B11, a state-of-use determination unit B12, a mode storage unit B13, and a mode-switching unit B14. The packet transmission/reception unit B2 includes a flow-control unit B21 and a priority-control unit B22.

Here, the control unit B1 shown in FIG. 2 corresponds to the CPU 111, RAM 112, and flash ROM 113 that are shown in FIG. 1. Further, the packet transmission/reception unit B2 shown in FIG. 2 corresponds to the switching engine 121, the MAC chips 1211, 1221 and 1231, the PHY 1212, 1222 and 1232, and the ports 1213, 1223 and 1233, all of which are shown in FIG. 1.

The packet transmission/reception unit B2 receives packets from the external terminals 21 through 23 and transmits the received packets to the external terminals 21 through 23. The flow-control unit B21 with which the packet transmission/reception unit B2 is furnished transmits a pause frame to the external terminals 21 through 23, thereby causing them to interrupt transmission of packets. It will be appreciated that an alternative configuration may perform any given function that causes reduction in the transmission speed of the packets, instead of transmitting the pause frame. Thus, the flow control function of the flow-control unit B21 is an adjustment function of interrupting transmission of packets to a transmission destination, or of restricting the transmission speed, so as to prevent the buffer from overflowing.

When the flow control function is operative, the buffer is prevented from overflowing. Therefore, it is possible to perform highly reliable communication. Moreover, it is possible to minimize loss of packets due to overflowing from the buffer, enabling reduction in frequency of performing the retransmission control for a TCP packet.

The priority-control unit B22 sets a degree of priority to a packet received from the external terminals 21 through 23 and carries out the priority control for transmitting packets in the order of the degree of priority. The priority control performed by the priority-control unit B22 stops functioning when the flow control function of the flow-control unit B21 is set to be operative, and the priority control functions only when the flow control function is set to be inoperative. Further, the priority-control unit B22 may be configured to perform band control (i.e., to secure a band for UDP packets while limiting a band for TCP packets according to the present embodiment) that secures a usable band or limit a band for each of the packet categories, in addition to performing the aforementioned priority control. Furthermore, the priority-control unit B22 may also be configured to perform both the priority control and the band control.

A priority degree utilized by the priority-control unit B22 can be determined on the basis of whether a packet is a TCP packet or a UDP packet. Alternatively, the priority may be determined on the basis of the port 1213, 1223 or 1233 through which the individual packets are received or transmitted. Further, the priority may be determined on the basis of Priority Code Point (PCP) specified by the IEEE802.1p Standard. Optionally, the priority may be determined on the basis of the Type-of-Service (ToS) value or the Differentiated-Services-Code-Point (DSCP) value in the IP header a packet includes. The priority may also be determined utilizing the port number that a packet includes.

The present embodiment is configured to set a degree of priority for the priority-control unit B22 higher for UDP packets than for TCP packets. This makes it possible to carry out communications with high real-time responsiveness when the priority-control unit B22 performs the priority control.

The packet information acquisition unit B11 acquires packet information from the packet transmission/reception unit B2, the information received thereby. The state-of-use determination unit B12 determines a state of use of the network relay device 10 on the basis of the packet information that the packet information acquisition unit B11 has acquired. Further, the state-of-use determination unit B12 determines a mode as to whether to set the flow control function of the flow-control unit B21 to be operative or inoperative on the basis of the determined state of use and writes the determined mode to the mode storage unit B13 as mode information.

The mode-switching unit B14 obtains, from the mode storage unit B13, the mode information that has been determined based on the suitability for the state of use of the network relay device 10, and switches the flow control function of the flow-control unit B21 between operative and inoperative. Here, the setting of the flow control function is switched between operative and inoperative in the process of Auto Negotiation (an automatic negotiation) in compliance to IEEE802.3 Standard. Therefore, this process requires re-connection between the network relay device 10 and the external terminals 21 through 23 when switching the flow control function between operative and inoperative.

In the network relay device configured as described above, the CPU 111 periodically executes a periodical process at predetermined temporal intervals, for example, 1 second or less.

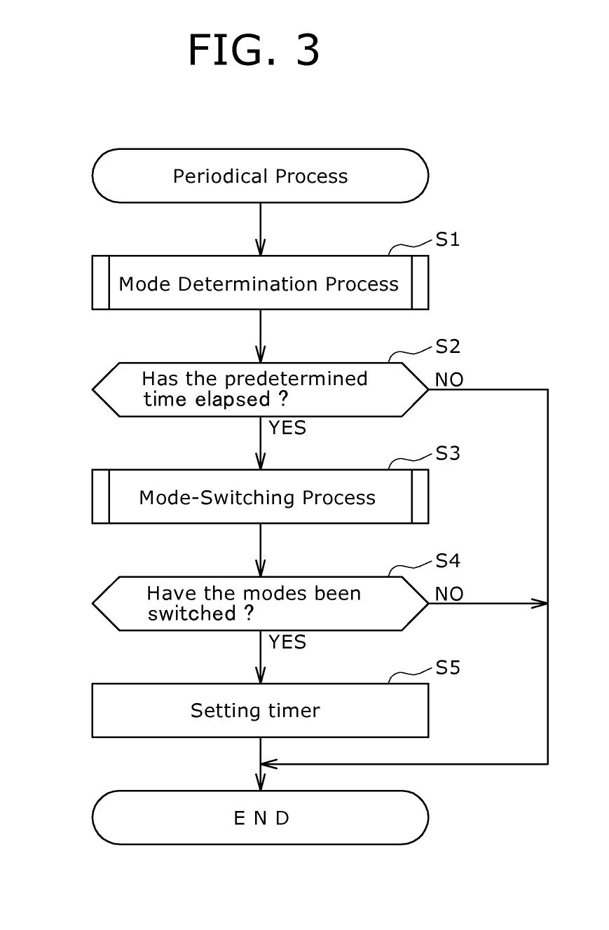

The periodical process executed by the CPU 111 (i.e., the control unit B1 shown in FIG. 2) is described with reference to FIG. 3 as follows. The control unit B1 first executes a mode determination process (S1). The mode determination process is a process for determining a state of use of the network relay device 10 on the basis of the information acquired by the packet information acquisition unit B11 and determining whether to set the flow control function to be operative or inoperative, the function that the packet information acquisition unit B11 has.

After the mode determination process, the control unit B1 determines whether a predetermined period of time has elapsed (S2). The timer is for determining a minimum period of time to the next switching of modes after the mode-switching unit B14 switches the modes and for inhibiting a continuous switching of the modes within a period of time regulated by the timer. Determining that the time has elapsed (Yes for S2) (the event is also described as “a fullness of time” herein), the control unit B1 shifts the process to a mode-switching process (S3). In contrast, if the control unit B1 determines that the time has not elapsed (No for S2), it ends the present periodical process without shifting the process to a mode-switching process.

The mode-switching process is a process performed by the mode-switching unit B14 on the basis of the mode information determined in the mode determination process (S1) and is the process of switching modes between operative and inoperative, the modes of the flow control function that the flow-control unit B21 has.

After the mode-switching process, the control unit B1 determines whether the modes have been switched in the present periodical process (S4). If the control unit B1 determines that the modes have been switched (Yes for S4), it sets the timer (S5) and ends the present periodical process. The timer is set for specifying the shortest temporal interval of a switching of the modes in step S2 and is set for a period of time, such as 10 sec, 5 min or 0.5 h, that is, at least sufficiently longer than a temporal interval of the periodical process. Here, the time set to the timer may be a predetermined period of time. An alternative configuration may be so as to allow an administrator of the network relay device 10 to variably set the time.

Determining that the modes have not been switched in the present periodical process (No for S4), the control unit B1 ends the present periodical process without setting the timer, that is, maintains the state of a fullness of time. The reason for this is to enable the next periodical process to determine a fullness of time so as to shift the process to a mode-switching process, because the present state can be determined that the shortest temporal interval has already been exceeded while the modes have not been switched.

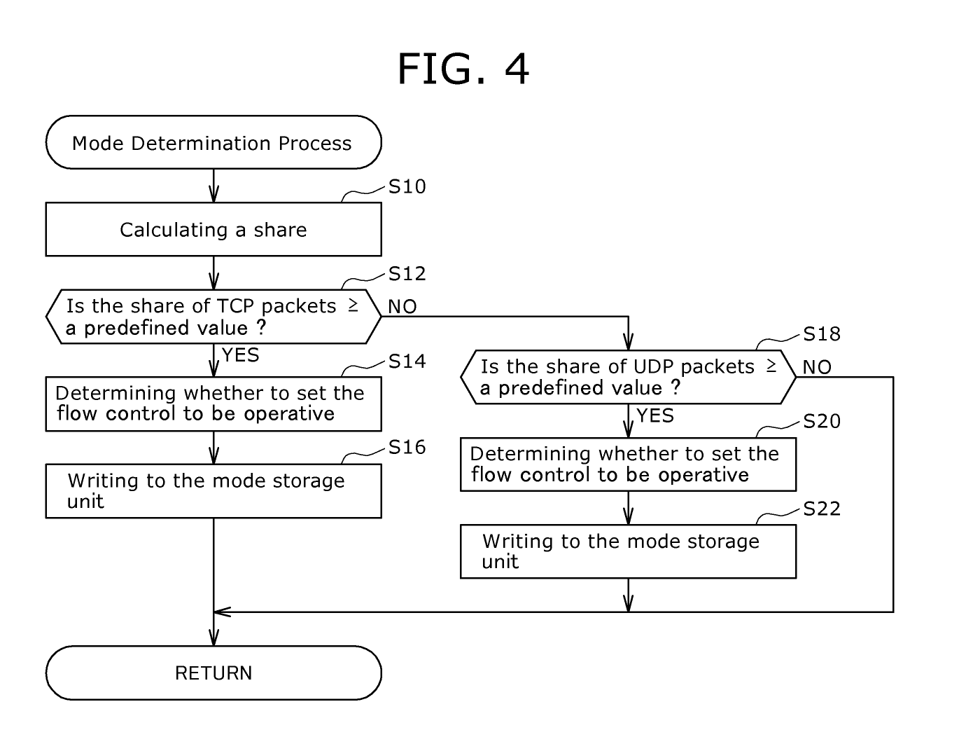

Next, a mode determination process performed in step S1 is described with reference to FIG. 4. The process is executed by the CPU 111 (i.e., the state-of-use determination unit B12 shown in FIG. 2). The packet information acquisition unit B11 acquires packet information from the packet transmission/reception unit B2, the information received thereby. The present embodiment is configured to use, of the acquired packet information, a category of packet (i.e., either a TCP packet or a UDP packet) based on a protocol.

The state-of-use determination unit B12 obtains the category of packet within the packet information from the packet information acquisition unit B11, and calculates the occupancy share (also simply “share” hereinafter) that the TCP packets and that the UDP packets occupy in the packets (S10) in their entirety. Here, the occupancy share of the TCP packets and of the UDP packets is defined as the proportion that the TCP packets and the UDP packets occupy in the total count of packets received within a predefined period of time. The state-of-use determination unit B12 then determines whether the share of the TCP packets is equal to or more than a predefined value (S12). It will be appreciated that the determination in step S12 corresponds to the process of determining a state of use of the network relay device 10 from the aspect of the share of TCP packets.

Determining that the share of the TCP packets is equal to or more than the predefined value (Yes for S12), the state-of-use determination unit B12 determines to set the flow control function to be operative (S14). Then the state-of-use determination unit B12 writes the result of the determination to the mode storage unit B13 as mode information (S16) and ends the present mode determination process.

In contrast, in step S12, if the state-of-use determination unit B12 determines that the share of the TCP packets is less than the predefined value (No for S12), it determines whether a share of the UDP packets is equal to or more than a predefined value (S18). It will be appreciated that the determination in step S18 corresponds to the process of determining a state of use of the network relay device 10 from the aspect of the share of the UDP packets. Determining that the share of the UDP packets is equal to or more than the predefined value (Yes for S18), the state-of-use determination unit B12 determines to set the flow control function to be inoperative (S20). Then, the state-of-use determination unit B12 writes the result of the determination to the mode storage unit B13 as mode information (S20) and ends the present mode determination process. In step S18, if the state-of-use determination unit B12 determines that the share of the UDP packets is less than the predefined value (No for S18), it ends the present mode determination process.

Here, the predefined values compared with the share of the TCP packets and that of the UDP packets in respective steps S12 and S18 are set at 60% for both shares according to the present embodiment. In this case, the flow control function will not be switched unless either one of the share of the TCP packets and that of the UDP packets is equal to or more than 60%. That is, for example, in a case where TCP packets and UDP packets occupy all packets transmitted/received by the network relay device 10, a mode will not be switched if the share of the TCP packets varies between 40% and 60% (that is, the share of the UDP packets varies between 40% and 60%).

This configuration makes it possible to suppress the frequency of switching the modes of the flow control function between operative and inoperative. That is, it is possible to determine a state of use of the network relay device 10 by comparing one of the share of the TCP packets and that of the UDP packets with a predefined value (in S12 or S18). By comparing both of them with the predefined value (in S12 and S18), however, it is possible to allow a larger difference between a threshold for setting the flow control function to be operative and a threshold for setting the function to be inoperative. In order to reduce the frequency of switching the modes for the present embodiment, it will be sufficient if a predefined value is set at a value higher than 50%. The larger the number, the lower is the frequency of switching the modes.

It will be appreciated that the predefined value used as a threshold of the share in steps S12 and S18 is preferably set variably by an administrator of the network relay device 10. In this case, a condition may be defined that both of the predefined values used in steps S12 and S18 are to be set the same, or respectively different. Further, the present embodiment is configured to compare the predefined values with both of a share of the TCP packets and that of the UDP packets (in S12 and S18), thereby enabling reduction in the frequency of switching the modes. A similar effectiveness will be realized by using either one of the share of the TCP packets and that of the UDP packets to compare with two different predefined values. It can be realized by modifying the configuration in which the predefined value is set, for example, at 60% (a first predefined value) for step S12 and whether the share of the TCP packets is equal to or less than 40% (a second predefined value) is determined in step S18. This case needs to calculate only the share of the TCP packets (or the UDP packets) as a portion of the entire number of packets in step S10, making it possible to realize the effectiveness of reducing a processing load as that much.

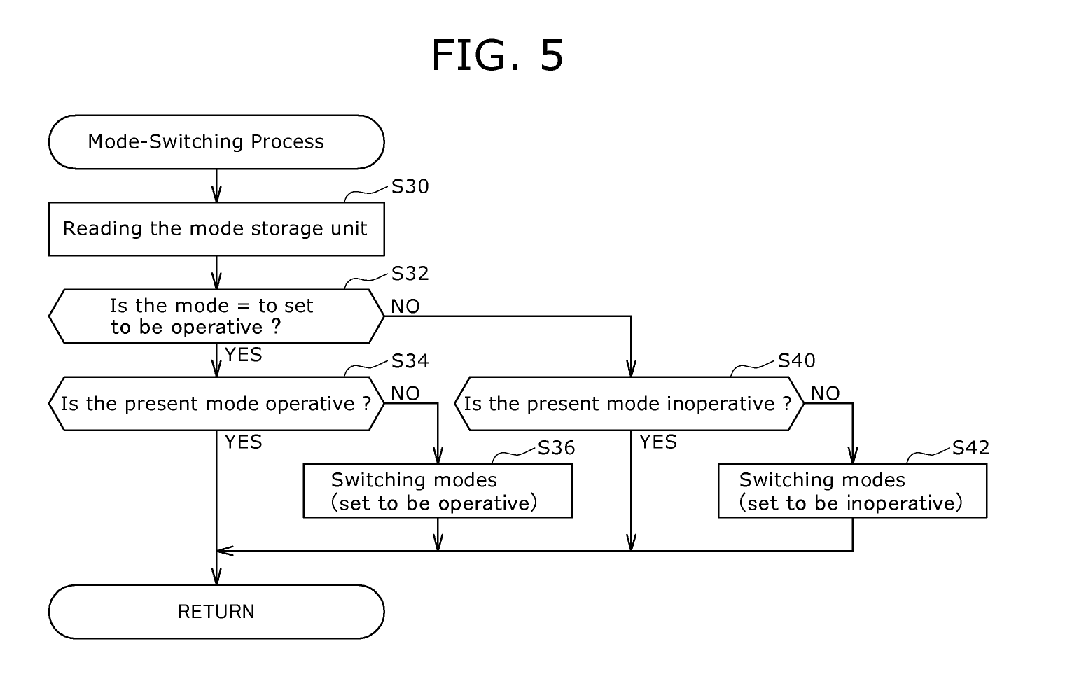

Next, a mode-switching process performed in step S3 is described with reference to FIG. 5. The process is executed by the CPU 111 (i.e., the mode-switching unit B14 shown in FIG. 2).

The mode-switching unit B14 obtains mode information of the flow-control unit B21 suitable for the state of use of the network relay device 10 from the mode storage unit B13 (S30). The mode-switching unit B14 then determines whether the obtained mode is a mode appropriate for setting the flow control function to be operative or inoperative (S32). Determining that the obtained mode is a mode appropriate for setting the flow control function to be operative (Yes for S32), the mode-switching unit B14 determines whether the flow control function is presently operative (S34). Determining that flow control function is presently operative (Yes for S34), requiring no switching of the modes, the mode-switching unit B14 ends the present mode-switching process. In contrast, if the mode-switching unit B14 determines that the flow control function is presently inoperative (No for S34), it switches the modes of the flow-control unit B21 to be operative (S36), and then ends the present mode-switching process.

Further, if the mode-switching unit B14 determines that the mode obtained in step S30 is a mode appropriate for setting the flow control function to be inoperative (No for S32), it determines whether the flow control function is presently inoperative (S40). Determining that the flow control function is presently inoperative (Yes for S40), requiring no switching of the modes, the mode-switching unit B14 ends the present mode switching process. In contrast, if the mode-switching unit B14 determines that flow control function is operative (No for S40), it switches the modes of the flow-control unit B21 to set the flow control function to be inoperative (S42). Then, the mode-switching unit B14 ends the present mode switching process.

The execution of the above described process causes the flow control function to be automatically set to be operative in a state of use where there is a high share of TCP packets requiring high reliability among the packets the network relay device 10 has received. Therefore, it is possible to suppress overflow of the buffer of the switching engine 121, enabling highly reliable communications. Moreover, it is possible to suppress a loss of packet otherwise caused by overflowing the buffer, thereby reducing the frequency of carrying out the retransmission control for the TCP packets.

In contrast, in a state of use where there is a high share of UDP packets requiring real-time responsiveness among the packets the network relay device 10 receives, the flow control function is automatically set to be inoperative. The automatic setting of the flow control function to be inoperative stops performing adjustments such as interrupting transmission of a packet to the terminal of a transmission destination and limiting the transmission speed. As a result, communications with higher real-time responsiveness are enabled in comparison with the case of setting the flow control function to be operative. Moreover, when the flow control function is set to be inoperative, the priority control of the priority-control unit B22 becomes functional according to the present embodiment. Further, the present embodiment is configured so that a degree of priority of UDP packets is set at higher than that of TCP packets in the priority control of the priority-control unit B22. As a result, a combination of setting the flow control function to be inoperative and performing the priority control for UDP packets with higher degree of priority makes it possible to realize communications with still higher real-time responsiveness compared with the case of setting only the flow control function to be inoperative.

Further, the present embodiment is configured to carry out the mode determination process (S1) and the mode-switching process (S3) as separate processes instead of completely synchronizing them. This configuration makes it possible to determine a mode by discriminating a state of use even in a period when the switching of modes is inhibited. This enables the update of mode information based on the latest state of use even in a period when the switching of modes is inhibited, making it possible to switch the modes suitable for the present state of use.

Here, in order to switch the flow control function between operative and inoperative, the process of Auto Negotiation needs to be executed, and therefore the network relay device 10 must be reconnected to the external terminals 21 through 23. The transmission/reception of packets between the network relay device 10 and the external terminals 21 through 23 is interrupted while the reconnection is carried out, and thereby the communication efficiency of packets is reduced if connection, disconnection and reconnection are frequently performed. In this respect, the present embodiment is configured to carry out the processes of steps S2 and S5 during the periodical process shown in FIG. 3, thereby regulating the shortest temporal interval of switching the modes. This configuration makes it possible to suppress reduction in the communication efficiency of packets associated with frequent switching of the modes of the flow control function.

Further, the configuration of comparing both the share of TCP packets and that of UDP packets with predefined values and the configuration of setting the predefined values for comparison at respective values higher than 50% in the mode determination process make it possible to allow a difference between a threshold for setting the flow control function to be operative and that for setting the function to be inoperative. As a result, it is possible to suppress a frequent switching of modes. Also in this respect, it is possible to keep the communication efficiency from decreasing due to reconnection between the network relay device 10 and the external terminals 21 through 23 associated with switching modes that would otherwise be frequent.

### Exemplary Modifications

Exemplary modifications of the above described present embodiment are described in the following.

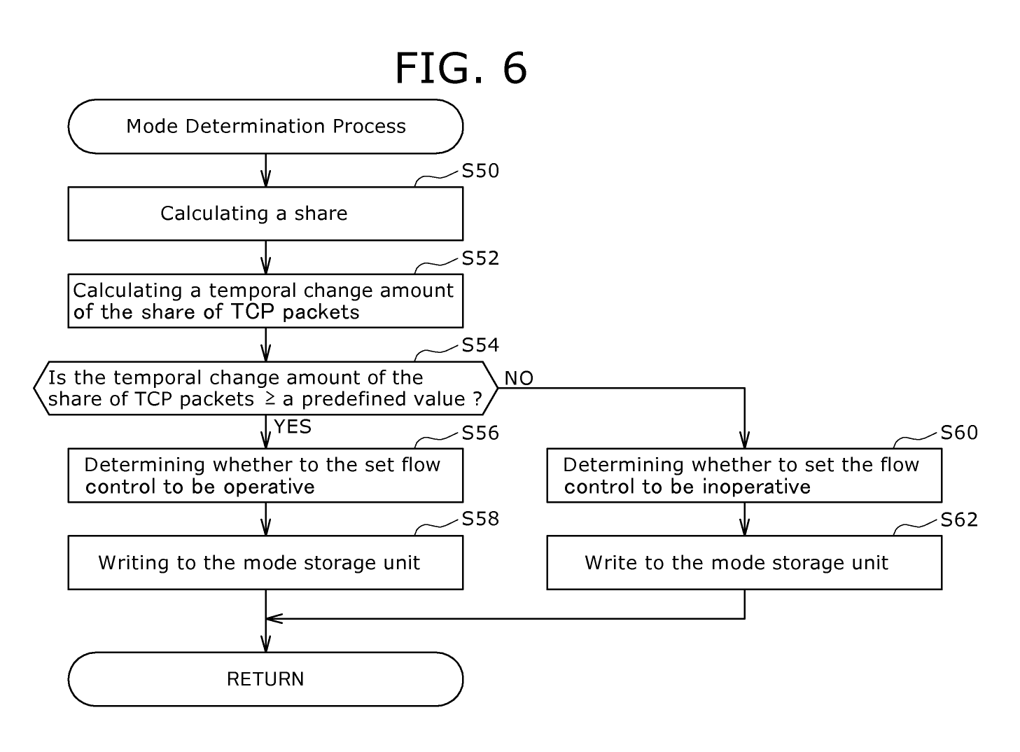

(1) A mode determination process executed by the state-of-use determination unit B12 may be configured as shown in FIG. 6.

That is, the state-of-use determination unit B12 obtains packet information from the packet information acquisition unit B11 and calculates a share of TCP packets per unit period of time (S50). Then, the state-of-use determination unit B12 calculates a temporal change amount of the shares of the TCP packets on the basis of the calculated shares (S52).

The state-of-use determination unit B12 determines whether the calculated temporal change amount is equal to or more than a predefined value (S54). Here, the aforementioned predefined value is set at a value enabling determination that the share of TCP packets is on the increase. It will be appreciated that the determination made in step S54 corresponds to the process of determining a state of use of the network relay device 10 from the aspect of the temporal change in the share of TCP packets. As a result of the determination in step S54, if the state-of-use determination unit B12 determines that the temporal change amount of the share of the TCP packets is equal to or more than the predefined value, that is, the share thereof is on the increase (Yes for S54), it determines to set the flow control function to be operative (S56). Then the state-of-use determination unit B12 writes the result of the determination to the mode storage unit B13 as mode information (S58) and ends the present mode determination process.

In contrast, if the state-of-use determination unit B12 determines that the temporal change amount of the share of the TCP packets is less than the predefined value (No for S54), it determines to set the low control function to be inoperative (S60). Then, the state-of-use determination unit B12 writes the result of the determination to the mode storage unit B13 as mode information (S62) and ends the present mode determination process.

The present exemplary modification makes it possible to predict a state of use for a near future on the basis of the temporal change in the share to switch the modes. It will be appreciated that the present exemplary modification is configured to make a determination based on only the temporal change in the share of the TCP packets, and that an alternative configuration may calculate also a temporal change in the share of the UDP packets for use in determining the state of use.

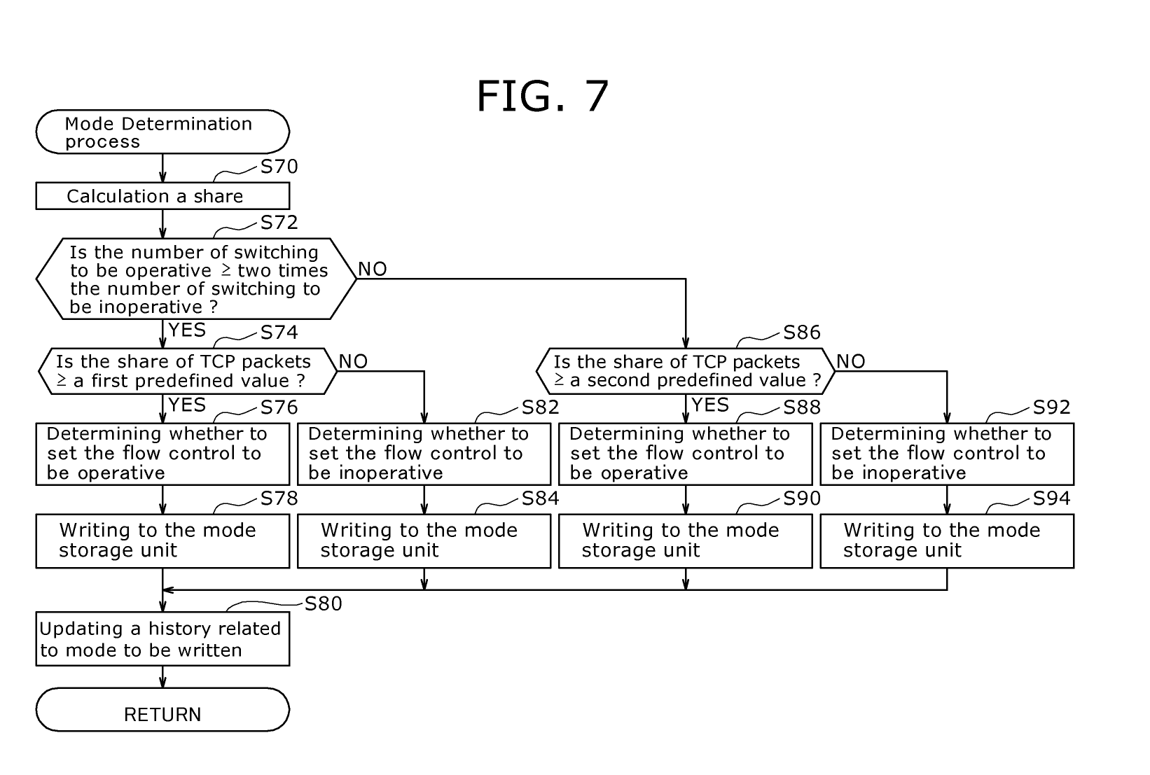

(2) A mode determination process executed by the state-of-use determination unit B12 may be configured as shown in FIG. 7.

That is, the state-of-use determination unit B12 obtains packet information from the packet information acquisition unit B11 and calculates a share of TCP packets of the entire packets per unit period of time (S70). Then, the state-of-use determination unit B12 refers to a history and compares, using the mode information written to the mode storage unit B13, the number of times the flow control function has been set to be operative with the number of times the function has been set to be inoperative (S72). Here, the history can be made referable by recording, in history-recording memory, pieces of mode information equivalent to any past given number of times or by recording, in the mode storage unit B13, mode information equivalent to any past given number of times, at every time the state-of-use determination unit B12 writes mode information to the mode storage unit B13.

If the state-of-use determination unit B12 determines that the number of times the flow control function has been set to be operative is equal to or more than the number of times the function has been set to be inoperative by a predetermined ratio (here, the ratio is predetermined at two times (2×)) (Yes for S72), it determines whether the share of the TCP packets is equal to or more than a first predefined value (S74). Determining that the share of the TCP packets is equal to or more than the first predefined value (Yes for S74), the state-of-use determination unit B12 sets the flow control function of the flow-control unit B21 to be operative (S76). The state-of-use determination unit B12 writes the result of the determination to the mode storage unit B13 as mode information (S78). Then, the state-of-use determination unit B12 updates a history related to a mode to be written (S80) and ends the present mode determination process.

In contrast, step S74, if the state-of-use determination unit B12 determines that the share of the TCP packets is less than the first predefined value (No for S74), it sets the flow control function of the flow-control unit B21 to be inoperative (S82). The state-of-use determination unit B12 writes the result of the determination to the mode storage unit B13 as mode information (S84). Then, the state-of-use determination unit B12 updates a history related to a mode to be written (S80) and ends the present mode determination process.

In step S72, if state-of-use determination unit B12 determines that the number of times the flow control function has been set to be operative is less than the number of times the function has been set to be inoperative by the predetermined ratio (here, the ratio is predetermined at two times (2×)) (No for S72), it determines whether the share of the TCP packets is equal to or more than a second predefined value (S86). Here, the second predefined value is set at higher than the first predefined value. Determining that the share of the TCP packets is equal to or more than the second predefined value (Yes for S86), the state-of-use determination unit B12 sets the flow control function to be operative (S88). The state-of-use determination unit B12 writes the result of the determination to the mode storage unit B13 as mode information (S90). The state-of-use determination unit B12 stores the written result of the determination as a history (S80) and ends the present mode determination process.

In step S80, if the state-of-use determination unit B12 determines that the share of the TCP packets is less than the second predefined value (No for S86), it sets the flow control function to be inoperative (S92). The state-of-use determination unit B12 writes the result of the determination to the mode storage unit B13 as mode information (S94). The state-of-use determination unit B12 stores the written result of the determination as a history (S80) and ends the present mode determination process. It will be appreciated that the determinations made in steps S72, S74 and S86 correspond to the processes of determining the states of use of the network relay device 10 from the aspects of a history and of the shares of TCP packets, and that the process is characterized in that the history is weighted in the determination.

A terminal having a strong tendency that the flow control function is set to be operative will be quickly changed to a state in which the flow control function is switched to be operative even if an event occurs, causing the flow control function to be temporarily set to be inoperative. Such switching may possibly cause reduction in the communication efficiency due to the associated reconnection. Then, the present exemplary modification is configured to record a history of the modes of the flow control function so as to enable reference to the history, and, if the number of times that the function is set to be operative is equal to or more than a predefined times (here, two times (i.e., 2×)) the number of times that the function is set to be inoperative, use the first predefined value lower than the second predefined value when determining a state of use by using the share of TCP packets (in S74).

This configuration suppresses frequency of the mode of the flow control function being switched to be inoperative when a terminal having a strong tendency that the flow control function is set to be operative is connected. It is therefore possible to suppress reduction in the communication efficiency due to switching the modes. It will be appreciated that the frequency of switching the modes can be further reduced by setting a predefined ratio, as a threshold for the determination, higher than two times (2×) in the above described example.

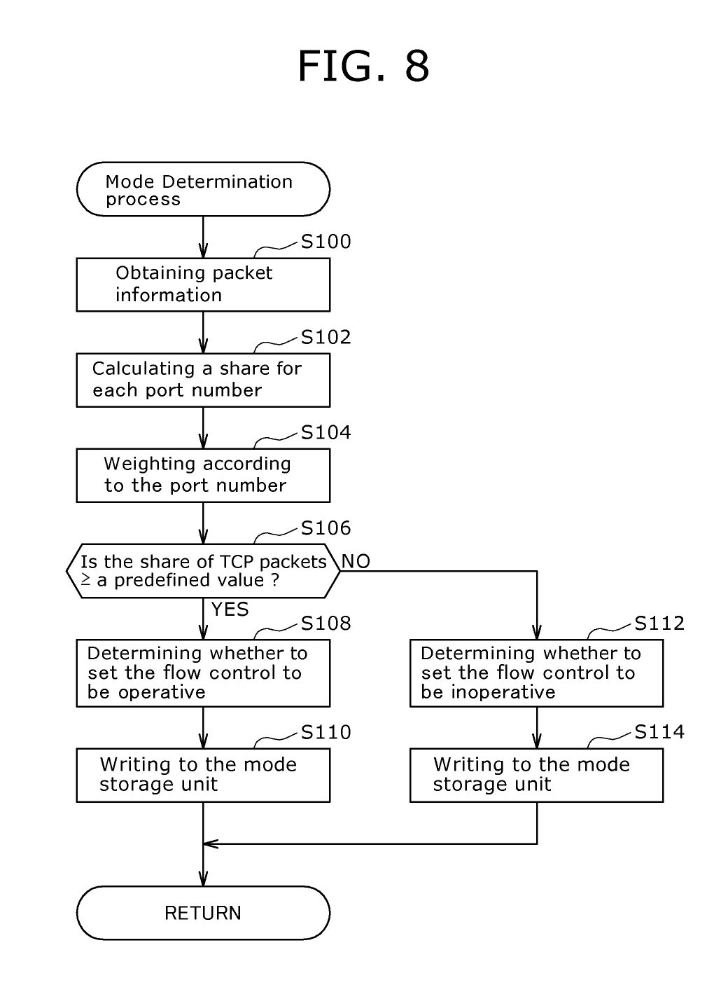

(3) A mode determination process executed by the state-of-use determination unit B12 may be configured as shown in FIG. 8.

That is, the state-of-use determination unit B12 obtains packet information from the packet information acquisition unit B11 (S100). Here, of the obtained packet information, a port number and a category of the packet are used. The state-of-use determination unit B12 calculates a share of TCP packets for each port number on the basis of the packet information (S102). Then, the state-of-use determination unit B12 weights the calculated share with a predefined value for each port number in accordance with the degree of priority of the program corresponding to the port number. That is, the state-of-use determination unit B12 weights the share of the TCP packets in accordance with the port number (S104). Weighting of a share is performed by multiplying, for example, “10”, to a share calculated based on the number of packets for a packet used for an important program while no multiplication is performed to a share calculated for packets used for other programs.

Then the state-of-use determination unit B12 determines whether the weighted share of the TCP packets is equal to or more than a predefined value, or less than the predefined value (S106). It will be appreciated that the determination in step S106 corresponds to the process of determining a state of the network relay device 10 from the aspect of the weighted share of TCP packets for each port number. Here, if the state-of-use determination unit B12 determines that the share of the TCP packets is equal to or more than the predefined value (Yes for S106), it sets the flow control function to be operative (S108). The state-of-use determination unit B12 writes the result of the determination to the mode storage unit B13 as mode information (S110) and then ends the present mode determination process. In contrast, in step S106, if the state-of-use determination unit B12 determines that the share of the TCP packets is less than the predefined value (No for S106), it sets the flow control function to be inoperative (S112). The state-of-use determination unit B12 writes the result of the determination to the mode storage unit B13 as mode information (S114) and then ends the present mode determination process.

The present exemplary modification is configured to refer to the port number of a packet and use the share weighted for each port number when determining a state of use. This configuration makes it possible to set the flow control function to be inoperative if a packet used for communications of an important program is the packet requiring real-time responsiveness. In contrast, if the packet used for communications of an important program is the packet requiring reliability, it is possible to set the flow control function to be operative. Therefore, the configuration makes it possible to switch the modes of the flow control function in accordance with a state of use that has a degree of importance of the program factored in.

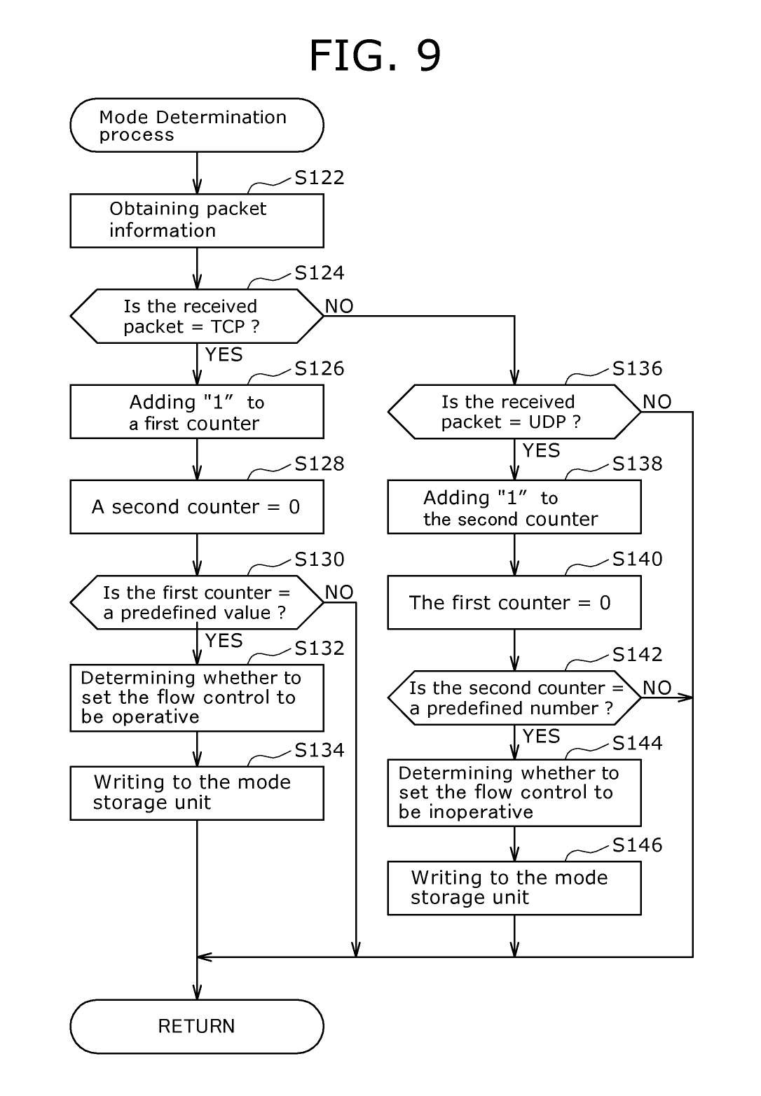

(4) A mode determination process executed by the state-of-use determination unit B12 may be configured as shown in FIG. 9.

That is, the state-of-use determination unit B12 determines a state of use of the network relay device 10 on the basis of continuity of the received packets. The state-of-use determination unit B12 counts the number of continuous TCP packets by using a first counter and counts the number of continuous UDP packets by using a second counter. Here, the initial values of the first and second counters are set at “0” when the power to the network relay device 10 is turned on. Then, the state-of-use determination unit B12 first obtains packet information from the packet information acquisition unit B11 (S122). The present exemplary modification is configured to use, of the packet information, a protocol so that the state-of-use determination unit B12 determines whether the protocol of a received packet is TCP (S124).

Determining that the protocol of the received packet is TCP (Yes for S124), the state-of-use determination unit B12 adds “1” to a value of the first counter (S126), and initialize a value of the second counter to “0” (S128). Then, determining that a value of the first counter is equal to a predefined value (Yes for S130), that is, the TCP packets continue for a predefined number, the state-of-use determination unit B12 sets the flow control function to be operative (S132). Then, the state-of-use determination unit B12 writes the result of the determination to the mode storage unit B13 as mode information (S134) and ends the present mode determination process. In contrast, in step S130, if the state-of-use determination unit B12 determines that the value of the first counter is not equal to the predefined value (No for S130), that is, a predefined number of the TCP packets are not continuously received, it ends the present mode determination process. It will be appreciated that the determination made in step S130 corresponds to the process of determining the state of use of the network relay device 10 from the aspect of the continuity of TCP packets.

In contrast, in step S124, if the state-of-use determination unit B12 determines that the protocol of the received packet is not TCP (No for S124), it determines whether the protocol of the received packet is UDP (S136). Determining that the protocol of the received packet is UDP (Yes for S136), the state-of-use determination unit B12 adds “1” to a value of the second counter (S138) and initializes a value of the first counter to “0” (S140). Then, the state-of-use determination unit B12 determines whether the value of the second counter is equal to a predefined value (S142). Determining that the value of the second counter is equal to the predefined value (Yes for S142), that is, the network relay device has continuously received the predefined number of the UDP packets, the state-of-use determination unit B12 sets the flow control function to be inoperative (S144). Then, the state-of-use determination unit B12 writes the determination result to the mode storage unit B13 as mode information (S146) and ends the present mode determination process.

In contrast in step S136, if the state-of-use determination unit B12 determines that the protocol of the received packet is not UDP (No for S136), it ends the present mode determination process. Further, in step S142, if the state-of-use determination unit B12 determines that the value of the second counter is not equal to the predefined value (No for S142), that is, the predefined number of the UDP packets is not continuously received, it ends the present mode determination process. It will be appreciated that the determination made in step S142 is the process of determining the state of use of the network relay device 10 from the aspect of continuity of UDP packets.

With regard to packets that the network relay device 10 receives, if a specific category (the same category) of packets, such as TCP packets, continues for a certain number, it is possible to predict that a share of the packets belonging to the specific category is high. This method may produce calculation of the share with reduced accuracy compared with the case of calculating a share on the basis of the total number of packets and the number of packets in specific category as in the above described embodiment. A use of the method for switching modes when a certain number of packets continue, however, makes it possible to grasp a state of use more quickly compared with the method of obtaining packets for a certain period of time and detecting the share of the packets by calculation. Therefore, the time for grasping a state of use, however, can be shortened, and therefore it is possible to set a mode appropriate for the current state of use of the network relay device 10 as a result although there will certainly be a possibility of producing reduced accuracy if only the accuracy of detection is focused.

(5) The above described embodiment is configured to assume TCP as a protocol used for communications with high reliability while UDP as a protocol used for communications with high real-time responsiveness. However, other protocols, such as Stream Control Transmission Protocol (SCTP), Resource Reservation Protocol (RSVP), and UDP-Lite, may be used instead of, or in addition to, TCP and UDP. In any case, they will be relatively categorized between a protocol emphasizing on reliability and a protocol emphasizing on real-time responsiveness, as with the above described embodiment and exemplary modifications.

(6) The above described embodiment is configured to use the number of packets for calculating a share of TCP packets and that of UDP packets. Alternatively, it may be appropriate to use the entire packet length received in any given period of time (i.e., the total volume of data contained in the packets), instead of the number of packets received in any given period of time.

In this case, packet information is obtained from the packet information acquisition unit B11, and, of the packet information, a protocol used by the packet received by the packet transmission/reception unit B2 and a packet length are used. Then, a process of adding data volumes of individual packets received in any given period of time for each category of packets is carried out, and thereby the total of data volumes included in the packets for each category thereof is obtained. By so doing, for example, even when the number of TCP packets is a little smaller than the number of UDP packets, a share of the TCP packets is larger in terms of data volume if a data volume included in the individual packets of the TCP packets is large. Thus, it is possible to determine a state of use based on the actual usage by determining a state of use on the basis of a data volume instead of the number of packets.

(7) It is also possible to carry out a mode determination process for each of the ports 1213, 1223 and 1233 and also the mode-switching process for each of the ports 1213, 1223 and 1233. Further, in a case where the ports 1213, 1223 and 1233 are divided by VLAN or the like, it is possible to carry out the process for each VLAN or the like. By so doing, the flow control function is always set to be inoperative, for example, for a port to be connected to an external terminal, such as a VoIP specific terminal, the terminal that is always involved in communications requiring real-time responsiveness, and thereby the communication efficiency can be improved.

(8) The above described embodiment and exemplary modifications (1) through (7) may be combined on an as appropriate basis. A combination of the above described embodiment and exemplary modifications (1) through (3) makes it possible to switch the modes of the flow control function in accordance with a more accurate state of use.

The present application is based on and claims the benefit of priority from prior Japanese Patent Application No. 2011-245808, filed on Nov. 9, 2011, the entire contents of which are incorporated herein by reference.

What is claimed is:

1. A network relay device for transmitting/receiving data packets, the network relay device comprising:
a state-of-use determination unit for determining, in response to at least either packets that the network relay device receives or packets that the network relay device transmits, the network relay device's state of use;
a flow-control unit for controlling flow volume of packets that the network relay device receives; and
a mode-switching unit for switching control by said flow-control unit between operative and inoperative, in response to the state-of-use determined by said state-of-use determination unit.

2. The network relay device according to claim 1, further comprising a priority-control unit for, when control by said flow-control unit has been rendered inoperative, performing a control function in order that transmission of packets for which real-time responsiveness is called for are transmitted with priority over packets for which reliability is called for.

3. The network relay device according to claim 1, wherein said state-of-use determination unit calculates an occupancy share occupied by packets of a predetermined category in packets received, and determines said state of use on the basis of the occupancy share.

4. The network relay device according to claim 3, wherein said state-of-use determination unit uses, as packets of said predetermined category, to calculate the occupancy share either packets for which real-time responsiveness is called for or packets for which reliability is called for.

5. The network relay device according to claim 3, wherein said state-of-use determination unit calculates the occupancy share on the basis of the number of packets received within a fixed period of time.

6. The network relay device according to claim 3, wherein said state-of-use determination unit weights the calculated occupancy share in correspondence with a port number used for designating a program at the destination where the packets are transmitted, and determines said state of use on the basis of the weighted share.

7. The network relay device according to claim 3, wherein said state-of-use determination unit determines said state of use on the basis of change in said occupancy share over time.

8. The network relay device according to claim 3, wherein said state-of-use determination unit records change over time of said flow-control unit being operative and inoperative as a history, and determines said state of use on the basis of said history and said occupancy share.

9. The network relay device according to claim 3, wherein said state-of-use determination unit determines said state of use on the basis of continuity in packets of a predetermined category during transmission of the packets, reception of the packets, or during both.

10. The network relay device according to claim 3, wherein said mode-switching unit inhibits switching of control by said flow-control unit between operative and inoperative until a predetermined period of waiting time elapses after switching of the control by said flow-control unit between operative and inoperative.

11. The network relay device according to claim 3, further comprising a plurality of ports used for connecting to external terminals, wherein:
said flow-control unit enabled to control flow volume of packets received by the network relay device at each of the ports; and
said mode-switching unit enabled to switch control by said flow-control unit between operative and inoperative for each of the ports.

12. The network relay device according to claim 3, wherein the network relay device is a switching hub.

13. The network relay device according to claim 1, wherein said state-of-use determination unit determines said state of use on the basis of continuity in packets of a predetermined category during transmission of the packets, reception of the packets, or during both.

14. The network relay device according to claim 1, wherein said mode-switching unit inhibits switching of control by said flow-control unit between operative and inoperative until a predetermined period of waiting time elapses after switching of the control by said flow-control unit between operative and inoperative.

15. The network relay device according to claim 1, further comprising a plurality of ports used for connecting to external terminals, wherein:
said flow-control unit enabled to control flow volume of packets received by the network relay device at each of the ports; and
said mode-switching unit enabled to switch control by said flow-control unit between operative and inoperative for each of the ports.

16. The network relay device according to claim 1, wherein the network relay device is a switching hub.

17. A method of controlling a network relay device enabled for transmitting/receiving data packets, and furnished with a flow-control unit for controlling flow volume of packets that the network relay device receives, the network relay device control method comprising:
a state-of-use determination step of determining, in response to at least either packets that the network relay device receives or packets that the network relay device transmits, the network relay device's state of use; and
a mode-switching step of switching control of packet-flow volume by said flow-control unit, between operative and inoperative, in response to the state-of-use determined by said state-of-use determination step.

18. A computer-readable non-volatile recording medium on which is recorded a program for controlling a network relay device enabled for transmitting/receiving data packets, and furnished with a flow-control unit for controlling flow volume of packets that the network relay device receives, the program for causing the network relay device to realize:
a state-of-use determination step of determining, in response to at least either packets that the network relay device receives or packets that the network relay device transmits, the network relay device's state of use; and
a mode-switching step of switching control of packet-flow volume by said flow-control unit, between operative and inoperative, in response to the state-of-use determined by said state-of-use determination step.

19. A network relay device comprising:
packet transmission/reception means for transmitting/receiving data packets to/from external terminal devices, said packet transmission/reception means including
temporary storage means for temporarily storing the transmitted/received packets, and
flow-control means for adjusting flow of packets into the network relay device so as to prevent overflow of packets from said temporary storage means; and
control means including
packet information acquisition means for acquiring from said packet transmission/reception means received-packet information identifying which protocol received packets use,
state-of-use determination means for obtaining from said packet information acquisition means the protocol-identifying received-packet information as received-packet categorizing information, and for calculating as an occupancy share based on the received-packet categorizing information what proportion received packets in a predetermined category occupy with respect to a total count of received packets in said temporary storage means, and outputting the occupancy share as state-of-use information, and
mode-switching means for switching said flow-control means between being operative and being inoperative according to the state-of-use information output by said state-of-use determination means.

20. A network relay device as set forth in claim 19, wherein said packet transmission/reception means further includes priority-control means, functioning only when said flow-control means is inoperative, for prioritizing transmission/reception of packets according to a predetermined criterion.
